(19) United States
(12) Patent Application Publication
(10) Pub. No.: US 2010/0331063 A1
(43) Pub. Date: Dec. 30, 2010

(54) METHOD AND APPARATUS FOR A SLIDING DISPLAY

(75) Inventors: Silas Grant, London (GB); Chee Yee Wong, London (GB); Damian Jame Reec Mycroft, Wellesbourne (GB)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/494,625

(22) Filed: Jun. 30, 2009

(51) Int. Cl. H04M 1/00

(52) U.S. Cl. 455/575.4

(57) ABSTRACT

In accordance with an example embodiment of the present invention, an apparatus comprises a display slidably coupled with a housing having a front face, the display being slidable across the front face of the housing, the display having at least three positions with respect to the housing, the display having a middle position with respect to the housing, the display exposing a first user interface element coupled with the housing on a first side of the display on the front face and a second user interface element coupled with the housing on second side of the display on the front face when the display is in the middle position.

### TECHNICAL FIELD

The present application relates generally to a method and apparatus for a sliding display.

### BACKGROUND

Electronic devices such as a personal digital assistants (PDA), mobile communication devices, or Global Positioning System (GPS) receivers may generally comprise multiple housings such as a top housing and a bottom housing, which are slideably coupled or coupled with one or more hinges. Electronic devices with slidably coupled top and bottom housings may have a closed configuration and at least one open configuration.

### SUMMARY

Various aspects of examples of the invention are set out in the claims.

According to a first aspect of the present invention, an apparatus comprises a display slidably coupled with a housing having a front face, the display being slidable across the front face of the housing, the display having at least three positions with respect to the housing, the display having a middle position with respect to the housing, the display exposing a first user interface element coupled with the housing on a first side of the display on the front face and a second user interface element coupled with the housing on second side of the display on the front face when the display is in the middle position.

According to a second aspect of the present invention, an apparatus comprises a display slidably coupled with a housing having a front face, the display being slidable across the front face of the housing, the display having a left position and a right position with respect to the housing, the display exposing at least one user interface element coupled with the housing on a left side of the display on the front face when the display is in the right position and the display exposing another at least one user interface element coupled with the housing on a right side of the display on the front face when the display is in the left position.

According to a third aspect of the present invention, a method comprises sliding a display from a first position to a second position with respect to a housing slidably coupled with the display, the sliding exposing at least one user interface element and covering another at least one user interface element; and displaying first information on the display related to the at least one user interface element and not displaying second information on the display related to the another at least one user interface element.

### BRIEF DESCRIPTION OF THE DRAWINGS

An example embodiment of the present invention and its potential advantages are understood by referring to FIGS. 1 through 5 of the drawings:

FIG. 1 is a diagram of an apparatus comprising a housing and a slidable display according to an example embodiment of the invention;

FIG. 2A is a diagram of the apparatus of FIG. 1 comprising a 3-position slidable display shown in a middle position according to an example embodiment of the invention;

FIG. 2B is a diagram of the apparatus of FIG. 1 comprising a 3-position slidable display shown in a left position according to an example embodiment of the invention;

FIG. 2C is a diagram of the apparatus of FIG. 1 comprising 3-position slidable display shown in a right position according to an example embodiment of the invention;

FIG. 3A is a diagram of the apparatus of FIG. 1 comprising a 2-position slidable display shown in a right position according to an example embodiment of the invention;

FIG. 3B is a diagram of the apparatus of FIG. 1 comprising a 2-position slidable display shown in a left position according to an example embodiment of the invention;

FIG. 4 is a block diagram of the apparatus of FIG. 1 according to an example embodiment of the invention; and

FIG. 5 is a flow diagram illustrating an example method for displaying information on a display of the electronic device of FIG. 4 according to an example embodiment of the invention.

### DETAILED DESCRIPTION OF THE DRAWINGS

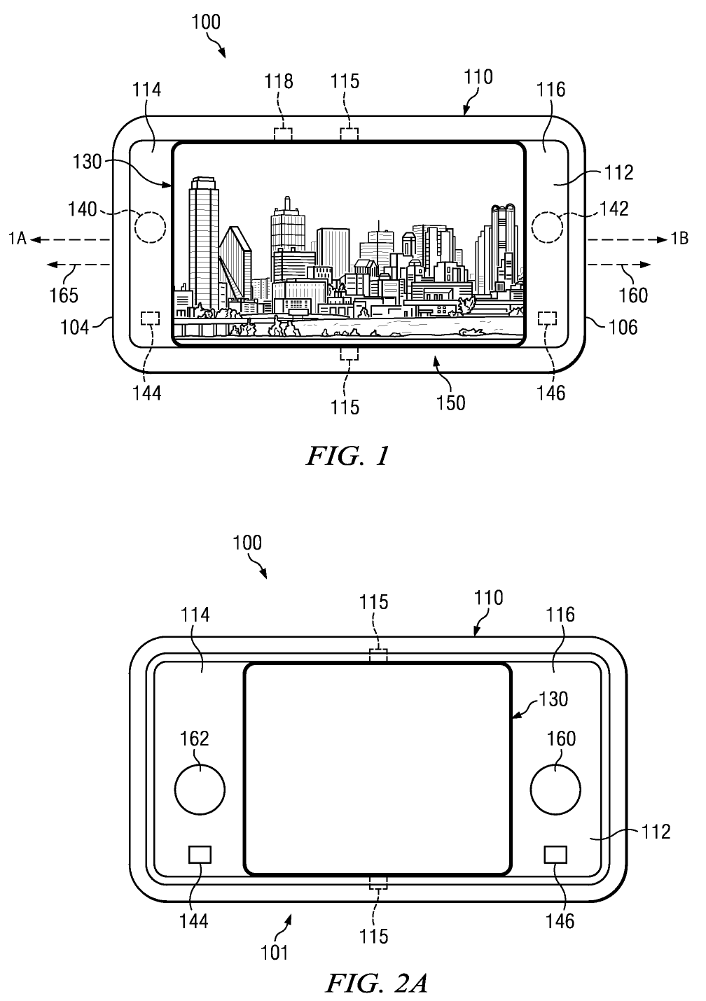

FIG. 1 is a diagram of an apparatus 100 comprising a housing 110 and a slidable display 130 according to an example embodiment of the invention. Apparatus 100 may be any electronic device such as a media player, camera, video camera, GPS receiver, mobile communications device and/or the like. According to FIG. 1, housing 110 has a front face 112, which may face the user during normal operation. Display 130 is slidably coupled with housing 110 such that display 130 is adapted to slide from a left end 104 to a right end 106 of front face 112 in a direction according to arrow 160 along line 1A-1B. Display 130 is further adapted to slide from right end 106 to left end 104 of front face 112 along line 1A-1B in a direction according to arrow 165. Display 130 may be any type of display, such as a touch screen display, which may be slidably coupled with housing 110.

In an example embodiment, housing I 10 may comprise a lip 150 around the perimeter of front face 112 to hold and guide display 130 when display 130 moves across front face 112 along line 1A-1B. In an example embodiment, apparatus may further comprise one or more magnetic components 115 coupled with housing 10 or display 130 arranged to bias display 130 into two or more positions as display 130 moves across front face 112. In another example embodiment, display 130 is not biased with respect to housing 110 and may be moved by a user smoothly across front face 112. Further, housing 110 and/or display may further comprise other components such as, for example, ball bearings (not shown) and/or lubrication (not shown), to allow display to move or slide across front face 112 easily. The term sliding used herein may include any type of moving of display 130 across front face 112 such as; for example, display 130 rolling on ball bearings.

In an example embodiment, housing 110 further comprises one or more user interface elements. User interface elements may include but are not limited to one or more output elements such as displays, light emitting diodes, speakers such as speakers 140 and 142 and/or the like. Further user interface elements may include but are not limited to one or more input or output elements such as touch-sensitive displays, controllers such as trackballs, buttons such as buttons 144 and 146 on housing 110 and/or the like. User interface elements such as speakers and buttons may be located on front face 112 of housing 110. For example, user interface elements may be located on front face 112 of housing 110 in an available area on left portion 114 or right portion 116 of housing 110.

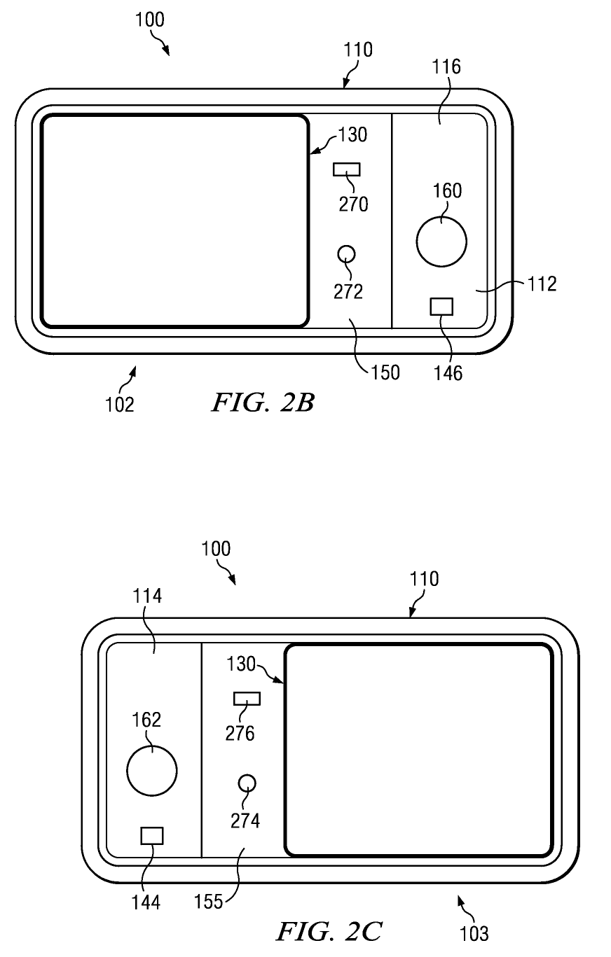

FIG. 2A is a diagram of the apparatus 100 of FIG. 1 comprising a 3-position slidable display 130 shown in a middle position 101 according to an example embodiment of the invention. When display 130 is in middle position 101, display 130 exposes at least one user interface element coupled with housing 110 on left portion 114 of housing 110, for example, speaker 162 and button 144. Further, when display 130 is in middle position 101, display 130 exposes at least one user interface element coupled with housing 110 on right portion 116 of housing 110, for example, speaker 160 and button 146.

In an example embodiment, apparatus 100 comprising a 3-position slidable display further comprises one or more magnetic components 115 coupled with housing 110 or with display 130. Magnetic components 115 are arranged to bias display 130 into three positions as display 130 is moved across front face 112. In another example embodiment, display 130 is not biased with respect to housing 110 and may be moved smoothly among 3-positions by a user across front face 112.

FIG. 2B is a diagram of the apparatus 100 of FIG. 1 comprising a 3-position slidable display 130 shown in a left position 102 according to an example embodiment of the invention. When display 130 is moved from middle position 101 (FIG. 2A) to left position 102, display 130 exposes user interface elements 270 and 272 located on right-middle portion 150 of housing 110. In FIG. 2B, user interface elements are both buttons, however, user interface elements may any input elements or output elements. When display 130 is moved by a user from middle position 101 (FIG. 2A) to left position 102, display 130 covers speaker 162 (FIG. 2A) and button 144 (FIG. 2A).

FIG. 2C is a diagram of the apparatus 100 of FIG. 1 comprising a 3-position slidable display 130 shown in a right position 103 according to an example embodiment of the invention. When display 130 is moved from middle position 101 (FIG. 2A) to right position 103, display 130 exposes user interface elements 274 and 276 located on left-middle portion 155 of housing 110. In FIG. 2C, user interface elements are both buttons, however, user interface elements may any input elements or output elements. When display 130 is moved by a user from middle position 101 (FIG. 2A) to right position 103, display 130 covers speaker 160 (FIG. 2A) and button 146 (FIG. 2A).

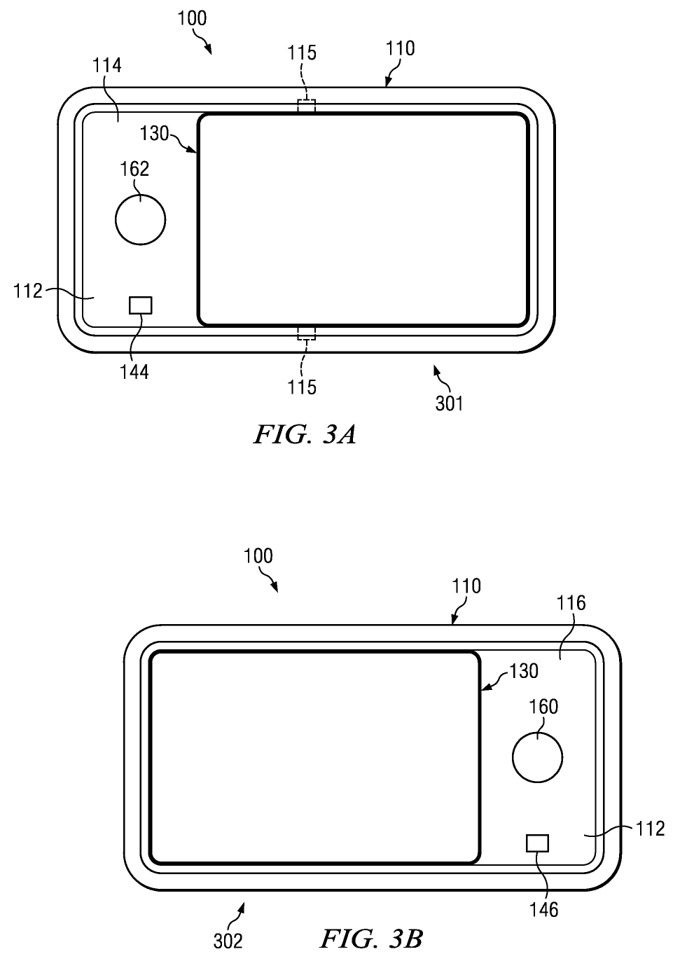

FIG. 3A is a diagram of the apparatus 100 of FIG. 1 comprising a 2-position slidable display 130 shown in a right position 301 according to an example embodiment of the invention. When display 130 is in right position 301, display 130 exposes at least one user interface element coupled with housing 110 on left portion 114 of housing 110, for example, speaker 162 and button 144. Further, when display 130 is in right position 301, display 130 covers at least one user interface element coupled with housing 110 on right portion 116 (FIG. 3B) of housing 110, for example, speaker 160 (FIG. 3B) and button 146 (FIG. 3B).

FIG. 3B is a diagram of the apparatus 100 of FIG. 1 comprising a 2-position slidable display 130 shown in a left position 302 according to an example embodiment of the invention. When display 130 is in left position 302, display 130 exposes at least one user interface element coupled with housing 110 on right portion 116 of housing 110, for example, speaker 160 and button 146. Further, when display 130 is in right position 302, display 130 covers at least one user interface element coupled with housing 110 on left portion 114 (FIG. 3A) of housing 110, for example, speaker 162 (FIG. 3A) and button 144 (FIG. 3A).

In an example embodiment, apparatus 100 comprising a 2-position slidable display further comprises one or more magnetic components 115 coupled with housing 110 or with display 130. Magnetic components 115 are arranged to bias display 130 in two positions as display 130 is moved across front face 112. In another example embodiment, display 130 is not biased with respect to housing 110 and may be moved smoothly among two positions across front face 112 by a user.

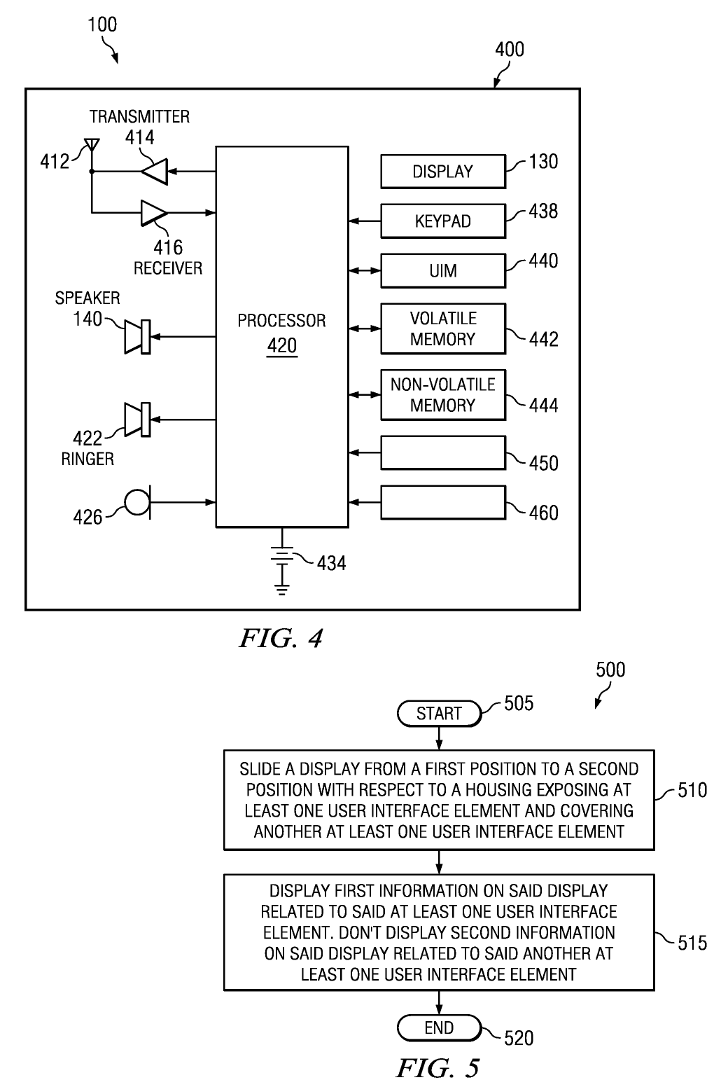

FIG. 4 is a block diagram of the apparatus 100 of FIG. 1 according to an example embodiment of the invention. According to FIG. 4, apparatus 100 (FIG. 1) is an electronic device 400. Electronic device 400 comprises at least one antenna 412 in communication with a transmitter 414 and a receiver 416. Electronic device 400 comprises a processor 420 and/or one or more other processing components. Processor 420 provides at least one signal to the transmitter 414 and receives at least one signal from the receiver 416. Further, electronic device 400 may comprise user interface elements that include one or more input elements and/or output elements, such as an earphone or speaker 140, a ringer 422, a microphone 426, a keypad 438, a display 130 and/or the like. User interface elements are coupled with processor 420. In an example embodiment, display 130 may be a touch screen, liquid crystal display, and/or the like capable of displaying text and graphical information. In an example embodiment, the electronic device 400 further comprises a GPS receiver 460 capable of determining the location of electronic device 400. In an example embodiment, the electronic device 400 further comprises a battery 434, such as a vibrating battery pack for powering various circuits to operate electronic device 400. Electronic device 400 further comprises a volatile memory 442 and a non-volatile memory 444 coupled with processor 420.

According to FIG. 4, electronic device 400 further comprises at least one sensor 450 for determining the position of display 130 according to FIGS. 2A, 2B, and 2C and FIGS. 3A and 3B. At least one sensor 450 may be any sensor(s) capable of detecting a position of display 130 (FIG. 1) with respect to housing 10 (FIG. 1) including but not limited to a light sensor, a motion sensor, a magnetic sensor and/or the like. At least one sensor 450 may be located anywhere on housing 110 and/or display 130 to accurately and reliably detect the position of display 130 with respect to housing 110. In an example embodiment, at least one sensor 450 is a light sensor 118 (FIG. 1) coupled with the bottom side of lip 150 (FIG. 1) and capable of detecting the position of display 130 with respect to housing 110.

In an example embodiment, processor 420 determines by polling sensor 450 that display 130 is in a particular position with respect to housing 130 (FIG. 1). For example, processor 420 may determine by polling at least one sensor 450 that a 3-position display 130 (FIG. 2A) is in middle position 101 (FIG. 2A), left position 102 (FIG. 2B), or right position (FIG. 2C). In another example embodiment, processor 420 may determine by polling at least one sensor 450 that a 2-position display 130 is in a right position 301 (FIG. 3A) or a left position 302 (FIG. 3B).

FIG. 5 is a flow diagram illustrating an example method 500 for displaying information on display 130 FIG. 1) of electronic device 400 (FIG. 4) according to an example embodiment of the invention. At 505, the method begins. At 510, a display, for example display 130 (FIG. 1) slides from a first position to a second position with respect to a housing, for example housing 110 (FIG. 1), exposing at least one user interface element and covering another at least one user interface element. In an example embodiment, display 130 has three positions such as display 130 (FIG. 2A), however, display 130, may have more or less than three positions with respect to housing 110. First position, for example, is middle position 101 (FIG. 2A) and second position, for example, is left position (FIG. 2B). At 510, when display 130 (FIG. 2A) slides from middle position 101 (FIG. 2A) to left position (FIG. 2B), at least one user interface element, for example, button 270, is exposed and another at least one user interface element, for example, speaker 162, is covered.

At 515, first information related to the at least one user interface element that was exposed when display 130 slid from middle position 101 (FIG. 2A) to left position 102 (FIG. 2B), for example, button 270, is displayed on display 130. For example, if button 270 is dial button, enabling electronic device 400 (FIG. 4) to make phone calls, first information displayed on display 130 may be a text input box indicating that a phone number is to be entered by a user. In another example, if button 270 requests electronic device 400 to begin acquiring satellites to determine the user's present location using GPS, first information displayed on display 130 may be an icon indicating that a GPS feature is now available to the user. At 515, second information related to another at least one user interface element, for example, speaker 162, which was covered when display 130 slid from middle position 101 to left position 102, is not displayed. For example, if in middle position 101 (FIG. 2A), electronic device 400 was functioning as a media player with a movie playing in display 130 and stereo sound emanating from speakers 162 and 160 (FIG. 2A), sliding display 130 from middle position (FIG. 2A) to left position (FIG. 2B) may indicate a new mode of operation, such as a navigation mode or a mobile communications mode. In this new mode of operation, for example, the movie from the previous mode of operation is temporarily paused and is no longer displayed on display 130. The method ends at 520.

Without in any way limiting the scope, interpretation, or application of the claims appearing below, a technical effect of one or more of the example embodiments disclosed herein may be a multi-position sliding display for an apparatus. Another technical effect of one or more of the example embodiments disclosed herein may be to display information on a display as a result of sliding a display with respect to a housing from one position to another position. Another technical effect of one or more of the example embodiments disclosed herein may be to not display information on a display as a result of sliding a display with respect to a housing from one position to another position.

Embodiments of the present invention may be implemented in software, hardware, application logic or a combination of software, hardware and application logic. The software, application logic and/or hardware may reside in non-volatile memory, volatile memory, or on a disk drive. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising
a display slidably coupled with a housing having a front face, said display being slidable across said front face of said housing, said display having at least three positions with respect to said housing, said display having a middle position with respect to said housing, said display exposing a first user interface element coupled with said housing on a first side of said display on said front face and a second user interface element coupled with said housing on second side of said display on said front face when said display is in said middle position.

2. An apparatus according to claim 1, wherein when said display is moved one position in a direction with respect to said housing from said middle position, said display exposes at least one user interface element and covers another at least one user interface element.

3. An apparatus according to claim 2, wherein said at least one user interface element is at least one input element and said another at least one user interface element is at least one output element.

4. An apparatus according to claim 2, wherein said at least one user interface element is a at least one output element and said another at least one user interface element is at least one input element.

5. An apparatus according to claim 2, wherein said display being adapted to bias in said at least three positions with respect to said housing using magnetic components.

6. An apparatus according to claim 1, wherein said apparatus is a camera.

7. An apparatus according to claim 1, wherein said apparatus is a media player.

8. An apparatus according to claim 1, wherein said apparatus is a mobile communications device.

9. An apparatus according to claim 1, wherein said first user interface element and said second user interface element are speakers.

10. An apparatus, comprising:
a display slidably coupled with a housing having a front face, said display being slidable across said front face of said housing, said display having a left position and a right position with respect to said housing, said display exposing at least one user interface element coupled with said housing on a left side of said display on said front face when said display is in said right position and said display exposing another at least one user interface element coupled with said housing on a right side of said display on said front face when said display is in said left position

11. An apparatus according to claim 10, wherein when said display is moved one position in a direction with respect to said housing, said display exposes at least one user interface element and covers another at least one user interface element.

12. An apparatus according to claim 10, wherein said display has two positions with respect to said housing.

13. An apparatus according to claim 12, wherein said display adapted to bias in said said left position and said right position with respect to said housing using magnetic components.

14. An apparatus according to claim 10, wherein said apparatus is a camera.

15. An apparatus according to claim 10, wherein said apparatus is a media player.

16. An apparatus according to claim 10, wherein said apparatus is a mobile communications device.

17. An apparatus according to claim 10, wherein said at least one user interface element or said another at least one user interface element is an input element.

18. A method comprising:
sliding a display from a first position to a second position with respect to a housing slidably coupled with said display, said sliding exposing at least one user interface element and covering another at least one user interface element; and
displaying first information on said display related to said at least one user interface element and not displaying second information on said display related to said another at least one user interface element.

19. A method according to claim 18, wherein said second information was displayed on said display when said display was in said first position.

20. A method according to claim 19, wherein said first information was not displayed on said display when said display was in said second position.
